(19) United States
(12) Patent Application Publication
(10) Pub. No.: US 2008/0243625 A1
(43) Pub. Date: Oct. 2, 2008

(54) Sharing Revenue With a User-Selected Entity

(76) Inventors: Matthew Adkisson, Boston, MA (US); Blaine Dangel, Boston, MA (US); Justin Holland, Boston, MA (US); Christopher Keenum, Boston, MA (US)

Correspondence Address: ROBERT PLOTKIN, PC, 45 BUTTERNUT CIRCLE, CONCORD, MA, 01742-1937, US

(21) Appl. No.: 11/694,033

(22) Filed: Mar. 30, 2007

(51) Int. Cl. G06Q 20/00; G06F 15/16

(52) U.S. Cl. 705/16; 709/203

(57) ABSTRACT

The activities of computer users are monetized. More specifically, revenue is generated in response to a revenue-generating event produced in response to a computer user's activity. The generated revenue is shared between a coordinating entity and an entity selected by the user.

### CROSS REFERENCE TO RELATED APPLICATIONS

This application is related to the following commonly-owned and co-pending U.S. patent application Ser. No. 11/634,038, filed on Dec. 5, 2006, entitled, “Donating Through Affiliate Marketing,” hereby incorporated by reference herein.

### BACKGROUND

1. Field of the Invention

The present invention generally relates to the field of e-commerce and, more particularly, to techniques for monetizing activities of a computer user.

2. Related Art

Affiliate marketing is a popular method of promoting Web businesses. Affiliates of a Web business are rewarded with a commission for every visitor, subscriber and/or customer provided through their efforts to the Web business. It is a modern variation of the practice of paying finder's-fees for introducing new customers to a business. Compensation may be made based on a variety of schemes including a certain value for each visit (“Pay per click”), registrant (“Pay per lead”), a commission for each customer or sale (“Pay per Sale”), or any combination thereof. More generally, advertising is a significant source of revenue on the Web.

### SUMMARY

Embodiments of the present invention are generally directed to techniques for monetizing activities of computer users. More specifically, embodiments of the present invention are directed to techniques for sharing revenue between a coordinating entity and an entity selected by a user in response to a revenue-generating event produced in response to the user's activity.

In one embodiment of the present invention, a computer-implemented method comprises: (A) receiving an entity identifier identifying a first entity specified by a user; (B) modifying a communication stream between a first process operated by the user and a second process in communication with the first process to produce a modified communication stream; (C) receiving first input provided by the user to the first process; (D) identifying revenue based on the modified communication stream and the first input; and (E) allocating some but less than all of the revenue to the first entity identified by the entity identifier.

In another embodiment of the present invention, a computer-implemented method comprises: (A) identifying a user identifier identifying a user; (B) identifying a first entity identifier identifying a first entity; (C) inserting data into a communication stream between a first process operated by the user and a second process in communication with the first process to produce a modified communication stream based on the user identifier and the first entity identifier; (D) receiving first input provided by the user to the first process; and (E) identifying a revenue-generating event based on the modified communication stream and the first input.

In yet another embodiment of the present invention, a computer-implemented method comprises: (A) receiving, from a computer program residing on a first device, an indication of a revenue-generating event generated in response to input provided by a user to the first device; (B) identifying, based on the indication, a first entity associated with the user; (C) identifying an amount of revenue associated with the revenue-generating event; and (D) allocating some but less than all of the revenue to the first entity.

Other features and advantages of various aspects and embodiments of the present invention will become apparent from the following description and from the claims.

### BRIEF DESCRIPTION OF THE DRAWINGS

FIGS. 1A-1C are dataflow diagrams of systems for monetizing user activity according to embodiments of the present invention;

FIG. 2 is an illustration of a toolbar interface in accordance with one embodiment of the present invention;

FIG. 3 is a flowchart illustrating a method for sharing revenue with an entity selected by a user by modifying communications from a client to a server in accordance with one embodiment of the invention; and

FIG. 4 is a flowchart illustrating a method for sharing revenue with an entity selected by a user by modifying communications from a server to a client in accordance with one embodiment of the invention.

### DETAILED DESCRIPTION

Embodiments of the present invention are generally directed to techniques for monetizing activities of computer users. In one embodiment, such techniques are used to enable recipient entities (such as charitable or nonprofit groups) to raise funds by monetizing activities (such as online shopping and Web browsing activities) of individuals such as their members or others interested in supporting the recipient entities. Users of the system initially register with a coordinating entity and designate a selected recipient entity (such as a particular nonprofit organization) to benefit from their activities. Each user also consents to the installation of communication modification software on his or her computer. The software tracks the user's web browsing activity and modifies communications between the user's computer and Web servers such that particular activities of the user (such as viewing or selecting an advertisement, or navigating to web sites) create revenue-generating events, such as a commission under an affiliate program. The generated revenue (e.g., commission) is shared between the coordinating entity and the recipient entity designated by the user.

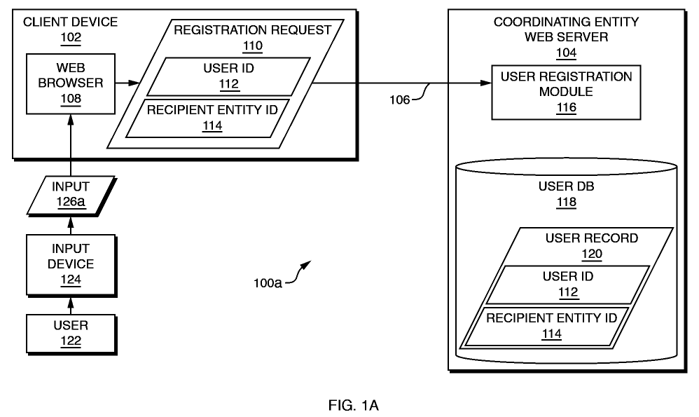

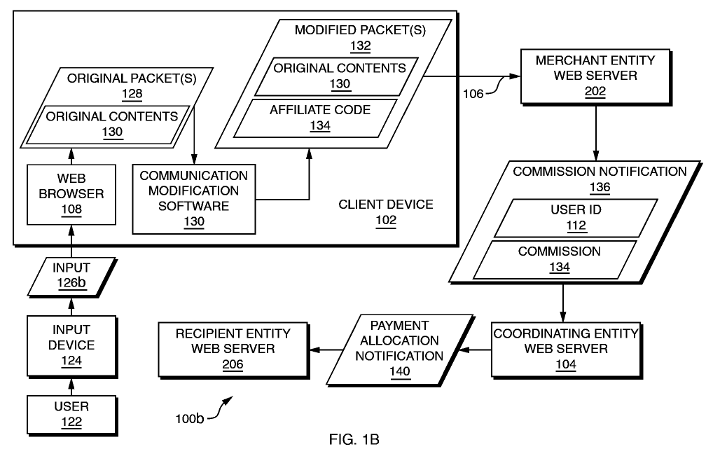

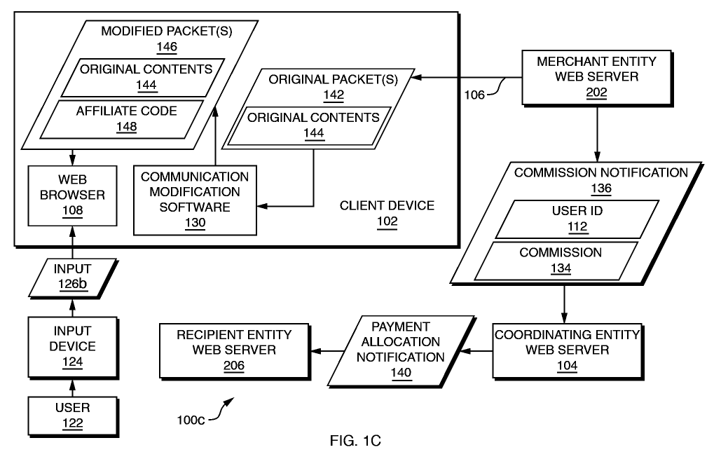

FIGS. 1A-1B illustrate a system 100 for monetizing activities of a user 122 according to embodiments of the present invention. FIG. 1A illustrates one aspect 100a of the system 100 and FIG. 1B illustrates another aspect 100b of the system 100. Reference number 100 will be used to refer generally to aspects 100a and 100b of the system 100.

The system 100 of FIGS. 1A-1B includes a client device 102 connected via a communication channel 106 to a Web server 104 operated by a coordinating entity. The channel 106 may for example, be the Internet, an intranet, or other network connection. In the case of the Internet, the Web server 104 is one of a plurality of servers that are accessible by a plurality of clients such as the client device 102.

The client device 102 may, for example, be a personal computer such as a Pentium®-based desktop or notebook computer running a Windows® operating system. Alternatively, for example, the client device 102 may be a portable communication device such as a personal digital assistant (PDA) or a cellular telephone. The client device 102 includes a browser 108, also referred to as a web client, which may, for example, be any of a variety of conventional web browsers, such as the Microsoft Internet Explorer® or Mozilla Firefox® web browsers.

The Web server 104 may host one or more Web sites. A Uniform Resource Locator (URL) identifies a network path to Web pages maintained by the server 104. As is well-known, clients and servers communicate with each other over the World Wide Web using the Hypertext Transfer Protocol (HTTP), which provides users access to files (which can be in different formats such as text, graphics, images, sound, video, etc.) using a standard page description language known as Hypertext Markup Language (HTML). HTML provides basic document formatting and allows developers to specify links to other servers and files. These links include “hyperlinks,” which are text phrases or graphic objects that conceal the address of a site on the Web.

A user of a client device (such as the client device 102) having an HTML-compatible browser (such as the browser 108) may retrieve a Web page (namely, an HTML formatted document) of a Web site by specifying a link via the URL. Upon such specification, the client device makes a transmission control protocol/Internet protocol (TCP/IP) request to the server identified in the link and receives the Web page in return.

Browsers can also support formats in addition to HTML. Examples of other supported formats include JPEG, PNG, and GIF image formats. Browsers can be extended to support other formats through the use of browser plug-ins. An example of a browser plug-in is Macromedia's Flash or Apple's QuickTime. The combination of HTTP and URL protocol specification allow Web pages to have embedded images, animations, video, sound, and streaming media in the Web page, or make them accessible through the Web page.

As the Web has matured, it has developed to enable users not only to display multimedia content, but also to execute remote (server-side) and local (client-side) software programs when accessing web sites. A variety of technologies exist for enabling such functionality.

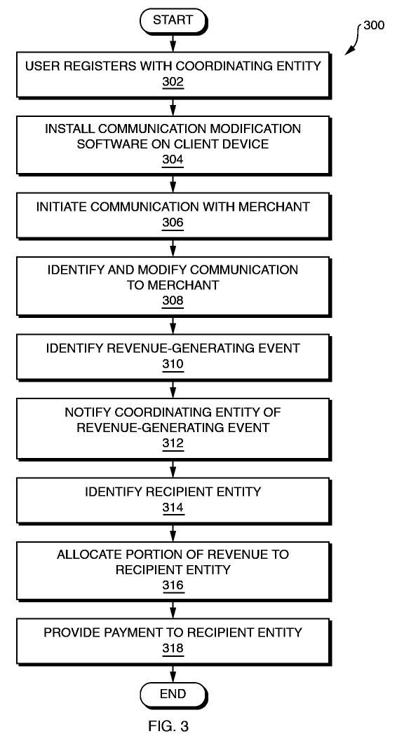

Referring to FIG. 3, a flowchart is shown of a method 300 performed by the system of FIGS. 1A-1B according to embodiments of the present invention. The user 122 registers with the coordinating entity associated with the coordinating entity server 104 (FIG. 3, step 302). The user 122 may register with the coordinating entity server 104 in any of a variety of ways. For example, the coordinating entity server 104 may host a web site which provides a graphical user interface through which the user 122 and other users may enter registration information over the Web. For example, the coordinating entity web server 104 may include a user registration module 116 which prompts the user 122 for, and receives from the user 122, a registration request 110. The registration request 110 may, for example, include a user identifier 112 identifying the user 122 (such as the user's real name and/or email address) and a recipient entity identifier 114 identifying a recipient entity (such as a nonprofit organization) which the user 122 desires to support financially. Assume for purposes of the following discussion that the recipient entity ID 114 identifies the entity associated with the recipient entity server 206 of FIG. 1B.

The user 122 may provide the registration request 110 using input 126a provided through any suitable input device(s) 124, such as a keyboard and/or mouse, coupled to the client device 102. The client device 102 transmits the registration request 110 over the connection 106 to the coordinating entity server 104, at which the user registration module 116 registers the user 122 with the coordinating entity associated with the coordinating entity server 104. The user registration module 116 may, for example, maintain a user registration database 118 in which information from the registration requests of multiple users is stored. For example, as shown in FIG. 1A, the user database 118 includes a record 120, corresponding to user 122, which includes the information provided by the user 122 in the registration request 110. The user registration database 118 may include similar records (not shown) corresponding to other users, containing identifiers of those users and of the recipient entities which those users have chosen to support financially.

Referring to FIG. 1B, the system 100 further includes a merchant entity web server 202 and a recipient entity web server 206. The recipient entity web server 206 may, for example, be owned, operated by, or operated on behalf of a recipient entity, such as a nonprofit organization (e.g., the Red Cross) which the user 122 desires to benefit financially. The coordinating entity server 104 may, for example, be owned, operated by, or operated on behalf of a coordinating entity, such as a for-profit company which performs some or all of the method 300 of FIG. 3 on behalf of the user 122, other users, the recipient entity associated with recipient entity server 206, and other recipient entities.

The merchant entity server 202 may, for example, be a server owned, operated by, or operated on behalf of a web-based merchant which sponsors an affiliate program, or which otherwise uses the server to compensate other entities for directing web traffic to the merchant entity's web site and/or for generating sales for the merchant entity. The coordinating entity associated with coordinating entity server 104 may be a member of the affiliate program of the merchant entity associated with merchant entity server 202.

Communication modification software 130 is installed on the client device 102 (step 304). The communication modification software 130 may be installed in any of a variety of ways. For example, when the user 122 registers with the coordinating entity (step 302), the coordinating entity web server 104 may present the user 122 with an end user license agreement (EULA) or other information requesting the user's permission to install the communication modification software 130 on the client device 102. The coordinating entity web server 104 may require the user 122 to grant such permission (such as by clicking on an “I agree” button) for the registration process to complete.

Upon receiving the user's permission, the coordinating entity server 104 may, for example, automatically install the communication modification software 130 on the client device 102 using any of a variety of well-known techniques. As another example, the coordinating entity server 104 may instruct the user 122 to download and install the communication modification software 130 manually, in response to which the user 122 may perform such a manual download and installation (such as by clicking on a download link and then executing the installation software that is downloaded to the client device 102).

As will be described in more detail below, the communication modification software 130 may take any of a variety of forms. For example, the communication modification software 130 may be implemented as a standalone program which executes automatically in the background on the client device 102 once the software 130 has been installed and each time the client device 102 is rebooted thereafter. As another example, the communication modification software 130 may be implemented as an extension, plug-in, or other add-on to the web browser 108 on the client device 102, in which case the communication modification software 130 may be installed using any mechanism supported by the web browser 108. Typically such extensions only execute while the web browser 108 itself executes, although this is not a requirement of the present invention. One example of such an extension is a web browser toolbar containing graphical user interface elements such as a search engine query box and links to other web sites (such as the web sites hosted by the merchant entity server 202 and/or the recipient entity server 206).

As yet another example, the communication modification software 130 may be implemented as a standalone application having its own user interface, such as an email or IRC client. The communication modification software 130 may be bundled with other software.

As will be described in more detail below, the communication modification software 130 tracks activity of the user 122 and modifies communications between the web browser 108 and web servers (such as the merchant entity web server 202) in response to input from the user 122.

For example, the user 122 may provide input 126b to the browser 108 to initiate communication with the merchant entity server 202 by, for example, entering a URL in the browser's address bar or by selecting a hyperlink to the merchant entity server 202 (FIG. 3, step 306). The communication modification software 130 monitors the user's browsing activity to identify and intercept one or more original data packets 128, having original content 130, directed by the client browser 108 to the merchant entity server 202. After intercepting the data packet(s) 128, the communication modification software 130 modifies the data packet(s) 128 by, for example, appending an affiliate code 134 to the original contents 130 of the data packet(s) 128, thereby producing modified packets 132 (step 308). The affiliate code 134 may, for example, identify the coordinating entity (associated with the coordinating entity server 104) and the user 122 (such as by using the user ID 112, e.g., the user's email address).

Assume, for purposes of example, that the merchant entity server 202 is the Amazon.com web server. If the user 122 were to enter the URL “www.amazon.com” in the address bar of the browser 108, the browser 108 may in response generate data packets 128 directed to the Amazon.com Web server 202. The communication modification software 130 may identify and intercept the original data packets 128 and append thereto the affiliate code 134 (and/or other data) by changing the packet heading from “amazon.com” to “amazon.com?id=freecause&user=john@mit.edu.” In this example, “freecause” is an identifier of the coordinating entity associated with the coordinating entity server 104, and “john@mit.edu” is an identifier of the user 122. The email address “john@mit.edu” may, for example, be the same as the user ID 112 originally provided by the user 122 to the user registration module 116 and stored in the registration record 120 in the user registration database 118.

As another example, if the user 122 were to enter the URL www.amazon.com in the address bar of the browser 108, or otherwise visit the www.amazon.com web site, the communication modification software 130 may identify and analyze the original data packets 128 and, in response, add the affiliate code 134 (and/or other data) to a cookie for www.amazon.com stored on the client device 102. Since cookie formats may vary from web site to web site, the communication modification software 130 may determine how to modify the www.amazon.com cookie, for example, by reference to a cookie format database stored locally at the client device 102 or accessed remotely from the coordinating entity web server 104. The communication modification software 130 may modify only those cookies for whose format is known.

A revenue-generating event is identified (FIG. 3, step 310). As mentioned above, a revenue-generating event may, for example, be any user activity that the merchant entity associated with server 202 and the coordinating entity associated with server 104 deem to require a payment from the merchant entity to the coordinating entity. Examples of revenue-generating events include, for example, e-commerce activities such as making a purchase through the merchant entity server 202 or viewing content hosted at the merchant entity server.

For example, in the case described above in which the modified packets 132 include an affiliate code 134, the merchant entity server 202 may receive the modified packets 132 and serve the home page of Amazon.com to the user's web browser 108 in response. Assume that at some point while browsing the Amazon.com web site, the user 122 makes a purchase through the web site. Such a purchase is an example of a revenue-generating event.

The merchant entity server 202 may recognize that the affiliate code 134 is included in the packets 132. Assume for purposes of example that the coordinating entity associated with the coordinating entity server 104 is enrolled in the merchant entity's (e.g., Amazon.com's) affiliate program, and that the coordinating entity's identifier in that program is “freecause.” In this case, the merchant entity server 202 may be configured, as part of the corresponding affiliate program, to credit the entity associated with the ID “freecause”—namely, the coordinating entity associated with server 104—with an affiliate commission.

Alternately or additionally, the communication modification software 130 on the client device 102 may, for example, determine that a revenue-generating event has occurred based on its monitoring of user activity. For example, the communication modification software 130 may track user browsing and purchasing activities to identify revenue-generating events.

The coordinating entity is notified of the revenue-generating event (step 312). For example, the merchant entity server 202 may notify the coordinating entity server 104 of the commission by transmitting a commission notification message 136 to the coordinating entity server 104. The message 136 may, for example, including the ID 112 of the user 122 and the amount 138 of the commission due to the coordinating entity. Similarly, if the revenue-generating event is identified by the communication modification software 130, then the communication modification software 130 may provide the notification 136 to the coordinating entity server 104.

In the event that both the merchant entity server 202 and the client device 102 provide notification to the coordinating entity server 104 of revenue-generating events, information provided by the client device 102 may, for example, be used to verify and provide advance notice of expected revenue from the merchant entity.

The coordinating entity identifies the recipient entity to which a portion of the revenue from the revenue-generating event should be allocated (step 314). The coordinating entity server 104 may, for example, identify the recipient entity to which the revenue portion should be allocated by using the user ID 112 as a key into the user registration database 118 and then identifying the recipient entity ID contained within the matching record. For example, in the embodiment illustrated in FIG. 1A, the coordinating entity server 104 may use the user ID 112 (e.g., email address) in the commission notification 136 to identify record 120 in the user registration database 118, and then identify the identifier 114 of the recipient entity selected by the user 122.

The coordinating entity associated with server 104 allocates a portion of the payment it has received for the revenue-generating event to the identified recipient entity (step 316). The coordinating entity may provide the recipient entity with a notification that revenue has been allocated to the recipient entity. For example, the coordinating entity server 104 may transmit a notification message 140 to the recipient entity server 206 notifying the recipient entity server 206 of the allocated payment. Furthermore, the coordinating entity may provide the allocated payment to the recipient entity (step 318). The coordinating entity thereby keeps one portion of the revenue generated from the revenue-generating event and allocates another portion of the revenue to the recipient entity. For example, each month or at other times the coordinating entity may mail checks or otherwise provide allocated payments to all recipient entities on behalf of whom the coordinating entity has received commissions.

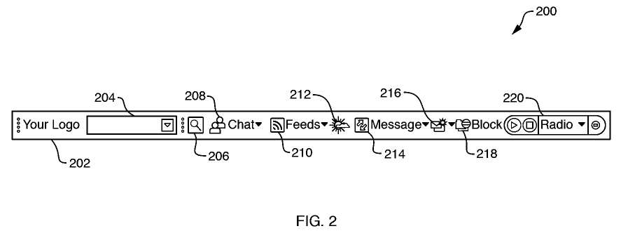

Referring to FIG. 2, an illustration is shown of a toolbar embodiment 200 of the communication modification software 130 according to one embodiment of the present invention. The toolbar 200 includes a logo 202, such as a logo of the recipient entity selected by the user 122. The logo 202 may act as a link to the recipient entity's web site, such that when the user 122 clicks on the logo 202, the toolbar 202 causes the web browser 108 to navigate to the web site of the recipient entity.

The toolbar 200 also includes a search bar 204 in which the user 122 may type search engine queries. Upon clicking on search button 206 (or hitting the ENTER key), the toolbar 200 causes he web browser 108 to submit the user's query to one or more predetermined search engines. The communication modification software 130 may modify the query in any of the ways described here.

The toolbar 200 further includes a chat button 208 which may, for example, act as a link to an online chat room for supporters of the recipient entity. The toolbar 200 further includes a feeds button 210 which links to one or more news (e.g., RSS) feeds, a weather button 212 which links to online weather forecasts, a message button 214 for enabling the user 122 to transmit instant messages to other supporters of the recipient entity, a message notification icon 216 for notifying the user 12 that new emails/messages have arrived, a bloc button 218 for enabling the user 122 to block pop-up windows, and a radio 220 control for enabling the user 122 to listen to Internet radio.

The particular user interface elements of the toolbar 200 in FIG. 2 are shown merely for purposes of example and do not constitute limitations of the present invention. The toolbar 200 may include any combination of any user interface elements. The communication modification software 130 may intercept and modify packets generated in response to user input directed to any of the user interface elements of the toolbar 200 in any of the ways described herein.

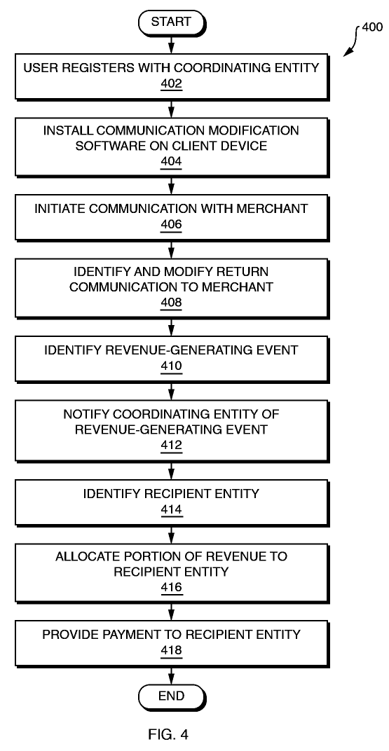

In the examples described above, the communication modification software 130 modifies outgoing packets 128 directed from the web browser 108 to the merchant entity server 202. This is not a limitation of the present invention. For example, as in the embodiment shown in the system 100c of FIG. 1C, the communication modification software 130 may additionally or alternatively modify incoming packets 142 from the merchant entity web server 202 directed to the web browser. FIG. 4 is a flowchart illustrated a method 400 that the system 100c uses to perform such a modification according to one embodiment of the present invention.

The user 122 registers with the coordinating entity (step 402), installs the communication modification software 130 on the client device 102 (step 404), and initiates communication with the merchant entity web server 202 (step 406) in the same manner as described above with respect to steps 302-306 of FIG. 3.

When the user 122 initiates communication with the merchant entity web server 202 in the case of FIG. 1C, however, the merchant entity web server 202 transmits original packet(s) 142, including original packet contents 144, to the client device 102 and intended for the web browser 108. If, for example, the user 122 clicks on a link in the browser 108 to the home page of www.amazon.com, then the merchant entity server 202 may return packets 142 including HTML code for the home page of www.amazon.com. Normally, the web browser 108 would receive such packets and display the www.amazon.com home page as intended by the merchant entity server 202. In the embodiment illustrated in FIGS. 1C and 4, however, the communication modification software 130 intercepts the original packets 142 and modifies them, such as by inserting an advertisement into them, thereby producing modified packets 146 (step 408). As a result, the web browser 108 displays the home page of www.amazon.com with a rendering of the advertisement 148 inserted into it. The advertisement 148, or other inserted content, may be displayed in any of a variety of ways, such as by displaying a banner advertisement integrated into the web page, by converting text in the web page into hyperlinks to advertisers, or by displaying a pop-up advertisement in a separate window.

The advertisement 148 or other inserted content includes information identifying the coordinating entity associated with server 104, such as the identifier “freecause.” As a result, when a revenue-generating event is identified (step 410), such as when the user 122 provides input 126b (e.g., a mouse click) selecting the rendering of the advertisement, a notification 136 of the revenue-generating event may be transmitted to the coordinating entity web server 104 (step 412). An identifier of the user 122 (such as the user ID 112, e.g., email address) may also be provided to the merchant entity web server 202 when the user 122 provides input 126b, using techniques that are well-known to those having ordinary skill in the art. As a result, the notification 136 may include the user ID 112, thereby enabling the coordinating entity web server 104 to identify the recipient entity (step 414) in the same manner as that described above with respect to step 314 of FIG. 3. The coordinating entity web server 104 may further allocate a portion of the generated revenue to the appropriate recipient entity (step 416) and provide payment to that recipient entity (step 418) in the manner described above with respect to steps 316 and 318 of FIG. 3.

The techniques disclosed herein have a variety of advantages. For example, techniques disclosed herein enable users (such as user 122) to enable recipient entities (such as charitable organizations) of their choice to receive financial support as a result of the users' web browsing activity. Because the user registration process may be implemented simply, and because the user may produce revenue-generating events that benefit the user's selected recipient entity as a side-effect of the user's web browsing activity, the user may benefit his desired entity with minimal effort. In particular, because the communications modification software 130 may intercept any communications between the browser 108 and merchant web server 202 without requiring modification to the web browser 108 and/or the user's browsing habits, revenue-generating events may be realized based on browsing activity which previously would not have generated any revenue. The techniques disclosed herein not only enable such revenue to be generated, but further enable such revenue to be shared with organizations chosen by users.

Recipient entities may benefit from the techniques disclosed herein for the same reason, and because it need not be necessary for recipient entities to register with the coordinating entity in order to receive portions of the revenue generated by users.

The techniques disclosed herein overcome various drawbacks of “malware,” such as “adware” and “spyware,” which operate without the user's knowledge and often in directly contradiction to the user's intent. As described herein, the user 122 may be required to grant express permission to install and execute the communications modification software 130 on the user's device 102. As a result, modifications performed by the communications modification software 130 may be made with the full knowledge and consent of the user 122.

Embodiments of the present invention may also advantageously be used to build online communities. For example, if the communication modification software 130 is implemented as a web browser toolbar or other software having a graphical user interface, the user interface may display the logo of the user's selected recipient entity to keep the recipient entity in the user's mind. Furthermore, the user interface may include, for example, links to the recipient entity's web site, web sites of related entities, and links to forums where the user 122 may communicate directly with other supporters of the recipient entity about the recipient entity.

These and other techniques may increase the frequency with which the user 122 and other supporters of the recipient entity visit the recipient entity's web site. More generally, the techniques disclosed herein may create increased loyalty, engagement, and retention of users of the recipient entity's web site.

The communication modification software 130 may be implemented in any of a variety of ways. For example, it may be implemented as a packet sniffer program which transparently identifies, intercepts, and modifies data transmitted and/or received by the web browser 108. The communication modification software 130 may execute in the background on the client device 102, and may operate independently of the web browser 108. For example, the communication modification software 130 need not be installed using an interface, such as a plugin or extension interface, provided by the web browser 108. Furthermore, the communication modification software 130 may be installed and executed as a separate executable file from the web browser 108. Moreover, the communication modification software 130 may execute and perform functions described herein even when the user interface of the web browser 108 is not being displayed to the user 122.

The communication modification software 130 may be made available in multiple implementations. For example, one version of the communication modification software 130 may be made available as a web browser toolbar, while another version of the communication modification software 130 may be made available as a background packet sniffer. The user 122 may choose which of these versions to install on the device 102. Installing both versions on the device 102 raises the possibility that the two versions will interfere with each other by, for example, redundantly inserting the affiliate code 134 and/or advertisement 148 into communications between the browser 108 and server 202. Therefore, if both versions are installed on the device 102, one of the two versions (e.g., the packet sniffer) may be configured to take priority over the other. For example, the toolbar version may, before modifying communications between the browser 108 and server 202, determine whether the packet sniffer version is executing on the device 102. If the toolbar version determines that the packet sniffer version is executing on the device 102, then the toolbar version may refrain from modifying communications between the browser 108 and server 202, thereby eliminating the possibility of redundant modifications. The packet sniffer may be given priority because, if it is implemented as a lower-level program in the TCP/IP stack than the toolbar, it is more likely to override any other software that may be executing on the client device 102.

These versions of the communications modification software 130 are provided merely as examples and do not constitute limitations of the present invention. The functions performed by the communications modification software 130 may be performed by software implemented in other forms.

Toolbar embodiments of the communications modification software 130 may take part in the techniques disclosed herein in a variety of ways. For example, such a toolbar may include a search engine bar, links to web sites, links to podcasts, links to RSS feeds, and so on. When the user 122 selects any such link, the toolbar may modify the outgoing packets as described above with respect to FIGS. 1B and 3.

As mentioned above, as used herein the term “entity” may refer to any one or more individuals. A recipient entity may, for example, be any entity that the user 122 selects to be rewarded for the user's activities. Examples of recipient entities include charitable or civic organizations (such as, for example, the Red Cross), or social associations, of which the user is a member (such as, for example, a university alumni group).

Although particular examples described herein refer to modifying HTTP streams between a web browser and a web server, this is not a limitation of the present invention. Rather, the communications modification software may modify other kinds of communications between processes. For example, the user-side software need not be a web client (browser) or even a “client” more generally, but may rather be any kind of software. Similarly, the merchant-side software need not be a “server,” but more generally may be any kind of software. Furthermore, the techniques disclosed herein may be applied to hardware devices rather than software.

In addition, the techniques disclosed herein may be applied to inter-process communication between processes executing on a single computer, rather than to process executing on multiple computers and communicating with each other over a communication channel. As an example, in one embodiment, if the user 122 enters text into a program (such as a word processing program), the communications modification software 130 may, in response, display a related advertisement to the user 122. Such display of an advertisement may constitute a revenue-generating event.

Although the term “merchant” is used in conjunction with the server 202, the server 202 need not be associated with a merchant. More generally the server 202 is merely the other party to the communications stream modified by the communications modification software 130.

As illustrated by the examples described herein, the user 122 may provide input which triggers a revenue-generating event either communications modification software 130 may modify a communications stream either before or after the user 122 provides input which triggers a revenue-generating event. For example, the communications modification software 130 may modify the communications stream in response to the user 122 navigating to a web page by inserting affiliate code 134 into the stream but before the user 122 makes a purchase which triggers a revenue-generating event. Alternatively, for example, if the communications modification software 130 modifies the communications stream in response to the user 122 navigating to a web page by inserting the advertisement 148 into the communications stream and the advertisement 148 is part of a “pay per view” advertising program, then the revenue-generating event (insertion of the advertisement 148) is generated in response to user input which occurs before the communications modification software 130 modifies the communication stream.

The coordinating entity may allocate a portion of the generated revenue to the recipient entity in any of a variety of ways. For example, the coordinating entity may allocate a predetermined percentage (e.g., 50%) of the generated revenue to the recipient entity or use any other formula or process to identify the amount to be allocated to the recipient entity.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

As used herein, the term “entity” means an individual or an organization such as, e.g., a business, an association (such as a social or political group), or a charitable or civic organization.

As used herein, the term “revenue-generating event” means any user activity that a participating merchant and a coordinating entity deem to require a payment from the merchant to the coordinating entity. Examples of revenue-generating events include e-commerce activities such as making a purchase on the merchant's Web site or browsing activities such as visiting a merchant's Web site.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) receiving an entity identifier identifying a first entity specified by a user;
(B) modifying a communication stream between a first process operated by the user and a second process in communication with the first process to produce a modified communication stream;
(C) receiving first input provided by the user to the first process;
(D) identifying revenue based on the modified communication stream and the first input; and
(E) allocating some but less than all of the revenue to the first entity identified by the entity identifier.

2. The method of claim 1, wherein (A) comprises receiving input from the user identifying the first entity.

3. The method of claim 1, wherein the first device comprises an HTTP client, wherein the second device comprises an HTTP server, and wherein (B) comprises modifying HTTP communications between the HTTP client and HTTP server.

4. The method of claim 3, wherein (B) comprises modifying an HTTP request sent by the HTTP client to the HTTP server.

5. The method of claim 4, wherein (B) comprises inserting an affiliate program code identifying the user into the HTTP request sent by the HTTP client to the HTTP server.

6. The method of claim 5, wherein (D) comprises identifying revenue provided by an affiliate program associated with the affiliate program code.

7. The method of claim 5, wherein (B) comprises inserting an affiliate program code identifying the user and a coordinating entity into the HTTP request sent by the HTTP client to the HTTP server.

8. The method of claim 3, wherein (B) comprises modifying an HTTP response sent by the HTTP server to the HTTP client.

9. The method of claim 8, wherein (B) comprises inserting code into the HTTP response representing an advertisement.

10. The method of claim 9, wherein (D) comprises identifying revenue generated by the advertisement.

11. The method of claim 1, wherein (E) comprises:
(E) (1) providing a first portion of the revenue to the first entity; and
(E) (2) providing a second portion of the revenue to a coordinating entity;
wherein the coordinating entity performs steps (A), (D), and (E).

12. The method of claim 1, wherein (B) comprises:
(B) (1) identifying at least one packet transmitted by the first process and having the second process as its destination;
(B) (2) modifying the at least one packet to include an identifier identifying the user, thereby producing at least one modified packet; and
(B) (3) forwarding the at least one modified packet for transmission to the second process.

13. The method of claim 12, wherein the first process executes on a first device, wherein the at least one packet is transmitted by the first process, wherein (B) (1) comprises:
(B) (1) (a) executing a third process on the first device;
(B) (1) (b) at the third process, intercepting the at least one packet; and
(B) (1) (c) at the third process, modifying the at least one packet to include the identifier identifying the user, thereby producing the at least one modified packet.

14. The method of claim 13, further comprising:
(B) (1) (e) at the second computer program, determining whether a predetermined fourth process is executing on the first device; and
wherein (B) (1) (b) comprises intercepting the at one packet in response to determining that the predetermined fourth process is not executing on the first device.

15. The method of claim 13, wherein the first process comprises a web browser and wherein the third process comprises a toolbar in the web browser.

16. The method of claim 13, wherein the first process comprises a web browser and wherein the third process comprises a plugin to the web browser.

17. The method of claim 13, wherein the first process comprises a web browser and wherein the third process comprises a program independent of the web browser.

18. The method of claim 1, wherein (C) is performed before (B), and wherein (B) is performed in response to (C).

19. The method of claim 18, further comprising:
(F) receiving second user input provided by the user to the first device in response to the modified communication stream; and
wherein (D) comprises identifying the revenue based on the modified communication stream and the second input.

20. The method of claim 1, wherein (C) is performed after (B).

21. A computer-implemented system comprising:
first entity identification means for receiving an entity identifier identifying a first entity specified by a user;
communication modification means for modifying a communication stream between a first process operated by the user and a second process in communication with the first process to produce a modified communication stream;
first input means for receiving first input provided by the user to the first process;
revenue identification means for identifying revenue based on the modified communication stream and the first input; and
revenue allocation means for allocating some but less than all of the revenue to the first entity identified by the entity identifier.

22. A computer-implemented method comprising:
(A) identifying a user identifier identifying a user;
(B) identifying a first entity identifier identifying a first entity;
(C) inserting data into a communication stream between a first process operated by the user and a second process in communication with the first process to produce a modified communication stream based on the user identifier and the first entity identifier;
(D) receiving first input provided by the user to the first process; and
(E) identifying a revenue-generating event based on the modified communication stream and the first input.

23. The method of claim 22, further comprising:
(F) identifying a second entity identifier identifying a second entity specified by the user; and
wherein (C) comprises modifying the communication stream between the first process and the second process to produce a modified communication stream based on the user identifier, the first entity identifier, and the second entity identifier.

24. A computer-implemented system comprising:
user identification means for identifying a user identifier identifying a user;
first entity identification means for identifying a first entity identifier identifying a first entity;
insertion means for inserting data into a communication stream between a first process operated by the user and a second process in communication with the first process to produce a modified communication stream based on the user identifier and the first entity identifier;
first input means for receiving first input provided by the user to the first process; and
revenue identification means for identifying a revenue-generating event based on the modified communication stream and the first input.

25. A computer-implemented method comprising:
(A) receiving, from a computer program residing on a first device, an indication of a revenue-generating event generated in response to input provided by a user to the first device;
(B) identifying, based on the indication, a first entity associated with the user;
(C) identifying an amount of revenue associated with the revenue-generating event; and
(D) allocating some but less than all of the revenue to the first entity.

26. The method of claim 25, further comprising:
(E) allocating a second portion of the revenue to a second entity.

27. The method of claim 25, wherein the method is performed by the second entity.

28. A computer-implemented system comprising:
revenue identification means for receiving, from a computer program residing on a first device, an indication of a revenue-generating event generated in response to input provided by a user to the first device;
first entity identification means for identifying, based on the indication, a first entity associated with the user;
revenue identification means for identifying an amount of revenue associated with the revenue-generating event; and
allocation means for allocating some but less than all of the revenue to the first entity.
